(19) United States
(12) Patent Application Publication
(10) Pub. No.: US 2024/0013009 A1
(43) Pub. Date: Jan. 11, 2024

(54) System for Translating Spoken Language

(71) Applicant: Latoya Green, Pensacola, FL (US)

(72) Inventor: Latoya Green, Pensacola, FL (US)

(21) Appl. No.: 18/346,940

(22) Filed: Jul. 5, 2023

Related U.S. Application Data
(60) Provisional application No. 63/358,379, filed on Jul. 5, 2022.

(51) Int. Cl. G06F 40/58; G07G 1/00; G07G 1/01; G07G 1/14; G10L 15/30; G10L 15/22; G06F 3/16; G06F 9/451

(52) U.S. Cl. CPC G06F 40/58; G07G 1/0045; G07G 1/01; G07G 1/14; G10L 15/30; G10L 15/22; G06F 3/167; G06F 9/454; G06F 3/0488

(57) ABSTRACT

A system for translating spoken languages is disclosed. The overall system includes a plurality of payment components that include a payment system and a cash register system. The payment system has a first visual interface and the cash register system has a second visual interface. The overall system includes a first microphone disposed on an upper corner of the first visual interface and a second microphone disposed on an upper corner of the second visual interface. The first microphone and the second microphone are activated by an indicia clicked on or depressed on that is disposed on the first visual interface and the second visual interface that allows communication between a first person and a first language and a second person and a second language.

### CROSS REFERENCE TO RELATED APPLICATIONS

This application claims the benefit of U.S. Provisional Application No. 63/358,379 filed on Jul. 5, 2022. The above identified patent application is herein incorporated by reference in its entirety to provide continuity of disclosure.

### COPYRIGHT NOTICE

A portion of the disclosure of this patent document may contain material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

Additionally, this patent document may contain material which is subject to contest or competition sponsorship regulations. Therefore, because such regulations are not the focus of this document, it is anticipated that if such regulation were deemed to apply, appropriate components of the system for translating spoken language as described herein would be conformable thereto, according to the understanding of one skilled in the art.

### BACKGROUND OF THE INVENTION

The present invention relates to a system for translating. More specifically, the present invention relates to a system for translating spoken language.

There are many languages spoken by people, and not every pair of individuals necessarily shares a common “working” language with which they can communicate verbally. This may be particularly true at retail shops or outlets, airports, and other areas where multiple languages may be spoken or preferred. Whenever a common language for communication is lacking, business transactions may take a particularly long time to execute. The resulting delay may slow down business performance, customer and employee satisfaction, and have other negative effects.

Accordingly, there is a need for a system for translating spoken language that allows users without a common “working” language to communicate in a retail venue.

### SUMMARY OF THE INVENTION

In view of the foregoing disadvantages inherent in the known types of systems for translating spoken language now present in the prior art, the present invention provides a system for translating spoken language wherein the same may be utilized for providing convenience for the user when using a system for translating spoken language.

The present system for translating spoken language includes a server system with a processor system, a communications interface, a communications system, an input system and an output system, the server system having access to a communications network, a memory system with an operating system, a communications module, a web browser module, a web server application, and a non-transitory storage media for translating spoken language, the memory system is in communication with the server system through the communications network, and a plurality of payment components, wherein the payment components execute the non-transitory storage media for translating spoken language of the system for translating spoken language that resides on the memory system.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a system overview of a system for translating spoken language.

FIG. 2A shows a block diagram of a client system of the system for translating spoken language.

FIG. 2B shows a block diagram of a server system of the system for translating spoken language.

FIG. 3 shows a perspective view of a plurality of payment components, according to the present invention.

FIG. 4 shows a perspective view of a first visual interface and a second visual interface of the system for translating spoken language during use to select a preferred language.

FIG. 5 shows a perspective view of a mobile application of the system for translating spoken language.

FIG. 6 shows an indicia disposed on the first visual interface and the second visual interfaces.

### DETAILED DESCRIPTION OF THE INVENTION

Reference is made herein to the attached drawings. Like reference numerals are used throughout the drawings to depict like or similar elements of the system for translating spoken language. The figures are intended for representative purposes only and should not be considered to be limiting in any respect.

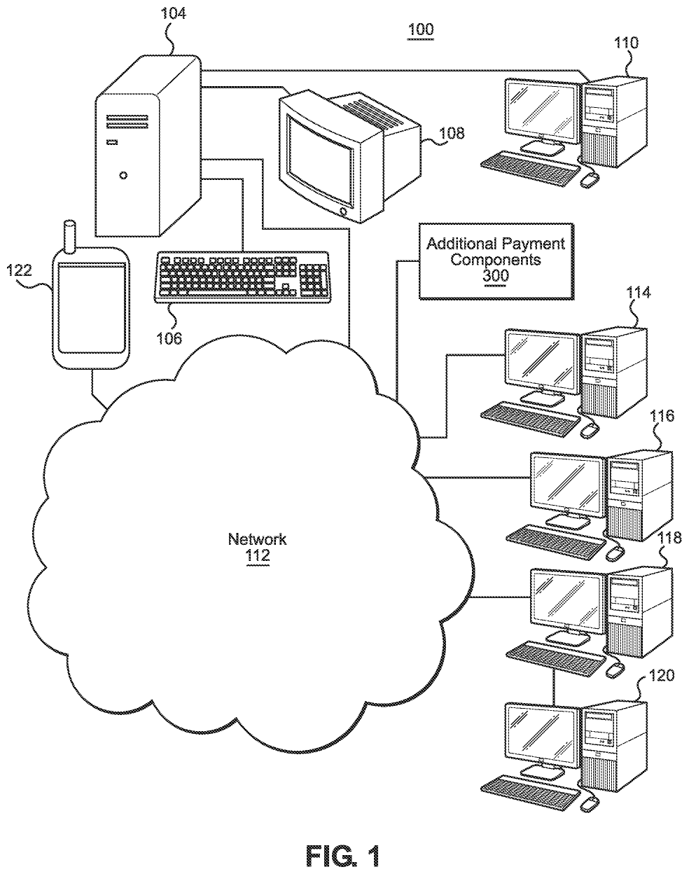

FIG. 1 shows a system overview of a system for translating spoken language 100.

The overall system 100 includes a server system 104, an input system 106, an output system 108, a plurality of client systems 110, 114, 116, 118 and 120, a communications network 112, and a hand-held device 122. In other embodiments, the overall system 100 may include additional components and/or may not include all of the components listed above.

The server system 104 may include one or more servers. One server 104 may be the property of the distributor of any related software or non-transitory storage media. In other embodiments, the overall system 100 may include additional components and/or may not include all of the components listed above.

The input system 106 may be used for entering input into the server system 104, and may include any one of, some of, any combination of, or all of a keyboard system, a mouse system, a track ball system, a track pad system, a plurality of buttons on a handheld system, a scanner system, a wireless receiver, a microphone system, a connection to a sound system, and/or a connection and/or an interface system to a computer system, an intranet, and/or the Internet (i.e., IrDA, USB), for example.

The output system 108 may be used for receiving output from the server system 104, and may include any one of, some of, any combination of or all of a monitor system, a wireless transmitter, a handheld display system, a printer system, a speaker system, a connection or an interface system to a sound system, an interface system to one or more peripheral devices and/or a connection and/or an interface system to a computer system, an intranet, and/or the Internet, for example.

The overall system 100 illustrates some of the variations of the manners of connecting to the server system 104, which may be an information providing website (not shown). The server system 104 may be directly connected and/or wirelessly connected to the plurality of client systems 110, 114, 116, 118 and 120 and are connected via the communications network 112. Client systems 120 may be connected to the server system 104 via the client system 118. The communications network 112 may be any one of, or any combination of, one or more local area networks or LANs, wide area networks or WANs, wireless networks, telephone networks, the Internet and/or other networks. The communications network 112 may include one or more wireless portals (not shown). The client systems 110, 114, 116, 118 and 120 are any system that an end user may use to access the server system 104. For example, the client systems 110, 114, 116, 118 and 120 may be personal computers, workstations, laptop computers, game consoles, handheld network enabled audio/video players and/or any other network appliance.

The client system 120 accesses the server system 104 via the combination of the communications network 112 and another system, which in this example is the client system 118. The client system 120 is an example of a handheld wireless device 122, such as a mobile phone or a handheld network enabled audio/music player or the like, which may also be used for accessing network content.

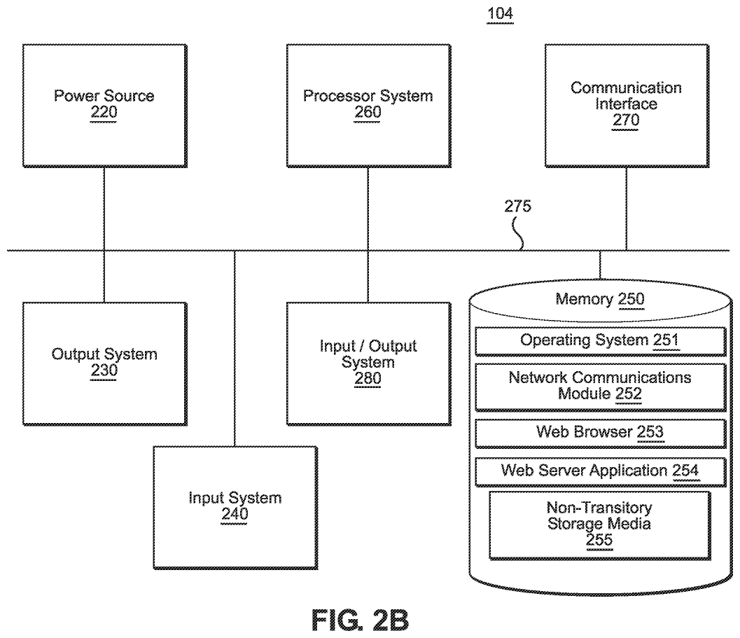

The system for translating spoken language 100 is described in more detail in FIGS. 3-6.

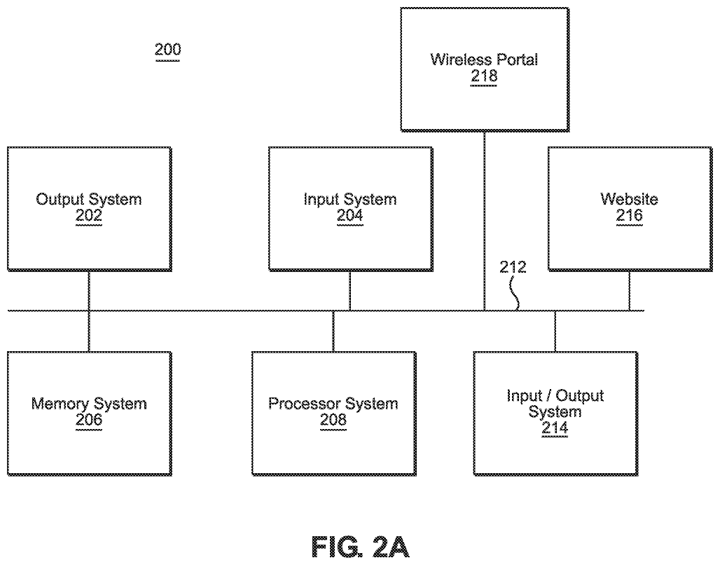

FIG. 2A shows a block diagram of a client system 200 of the system for translating spoken language 100.

The client system 200 may include an output system 202, an input system 204, a memory system 206, a processor system 208, a communications system 212, an input/output system 214, a website 216 and a wireless portal 218. Other embodiments of the client system 200 may not have all of the components and/or may have other embodiments in addition to or instead of the components listed above.

The client system 200 may be any one of the client systems 110, 114, 116, 118, 120, and/or handheld wireless device 122 that may be used as one of the network devices of FIG. 1. In other embodiments, the client system 200 may include additional components and/or may not include all of the components listed above. The output system 202 may include any one of, some of, any combination of or all of a monitor system, a wireless transmitter, a handheld display system, a printer system, a speaker system, a connection or an interface system to a sound system, an interface system to peripheral devices and/or a connection and/or an interface system to a computer system, an intranet, and/or the Internet, for example.

The input system 204 may include any one of some of, any combination of or all of a keyboard system, a mouse system, a track ball system, a track pad system, one or more buttons on a handheld system, a scanner system, a wireless receiver, a microphone system, a connection to a sound system, and/or a connection and/or an interface system to a computer system, an intranet, and/or the Internet (i.e., Infrared Data Association or IrDA, Universal Serial Bus or USB), for example. The memory system 206 may include, for example, any one of, some of, any combination of or all of a long-term storage system, such as a hard drive, a short-term storage system, such as a random-access memory; a removable storage system, such as a floppy drive or a removable drive, and/or a flash memory. The memory system 206 may include one or more machine-readable mediums that may store a variety of different types of information. The term machine-readable medium is used to refer to any medium that is structurally configured for carrying information in a format that is readable by a machine. One example of a machine-readable medium is a computer-readable medium. The memory system 206 also stores a non-transitory storage media for translating spoken language (FIG. 2B, 255).

The processor system 208 may include any one of, some of, any combination of, or all of multiple parallel processors, a single processor, a system of processors having one or more central processors and/or one or more specialized processors dedicated to specific tasks. The processor system 208 implements the programs stored in the memory system 206. The communications system 212 communicatively buttons the output system 202, the input system 204, the memory system 206, the processor system 208, and/or the input/output system 214 to each other. The communications system 212 may include any one of, some of, any combination of, or all of one or more electrical cables, fiber optic cables, and/or means for sending signals through air or water (i.e., wireless communications), or the like. Some examples of means for sending signals through air and/or water include systems for transmitting electromagnetic waves such as infrared and/or radio waves and/or systems for sending sound waves.

The input/output system 214 may include devices that have the dual function as input and output devices. For example, the input/output system 214 may include one or more touch sensitive screens, which display an image and therefore are an output device and accept input when the screens are pressed by a finger or a stylus, for example. The touch sensitive screens may be sensitive to heat, capacitance and/or pressure. One or more of the input/output devices may be sensitive to a voltage or a current produced by a stylus, for example. The input/output system 214 is optional and may be used in addition to or in place of the output system 202 and/or the input device 204.

The client systems 110, 114, 116, 118, 120 and the handheld wireless device 122 may also be tied into a website 216 or a wireless portal 218 which is also tied directly into the communications system 212. Any website 216 or wireless portal 218 would also include a non-transitory storage for translating spoken language (FIG. 2B, 255) and a website module (no number) to maintain, allow access to and run the website as well.

FIG. 2B shows a block diagram of a server system 104 of the system for translating spoken language 100.

The server system 104 may include a power source 220, an output system 230, an input system 240, a memory system 250, which may store an operating system 251, a communications module 252, a web browser module 253, a web server application 254, and a non-transitory storage for translating spoken language 255. The server system 104 may also include a processor system 260, a communications interface 270, a communications system 275 and an input/output system 280. In other embodiments, the server system 104 may include additional components and/or may not include all of the components listed above.

The output system 230 may include any one of, some of, any combination of, or all of a monitor system, a handheld display system, a printer system, a speaker system, a connection or interface system to a sound system, an interface system to one or more peripheral devices and/or a connection and/or interface system to a computer system, an intranet, and/or the Internet, for example.

The input system 240 may include any one of, some of, any combination of, or all of a keyboard system, a mouse system, a track ball system, a track pad system, one or more buttons on a handheld system, a scanner system, a microphone system, a connection to a sound system, and/or a connection and/or an interface system to a computer system, an intranet, and/or the Internet (i.e., IrDA, USB), for example.

The memory system 250 may include, for example, any one of, some of, any combination of, or all of a long-term storage system, such as a hard drive; a short-term storage system, such as random-access memory; a removable storage system, such as a floppy drive or a removable drive and/or a flash memory. The memory system 250 may include one or more machine-readable mediums that may store a variety of different types of information. The term machine-readable medium is used to refer to any medium capable of carrying information that is readable by a machine. One example of a machine-readable medium is a computer-readable medium. The memory system 250 may store one or more machine instructions for translating spoken language. The operating system 251 controls all software or non-transitory storage media and hardware of the overall system 100. The communications module 252 may enable the server system 104 to communicate on the communications network 112. The web browser module 253 allows for browsing the Internet. The web server application 254 serves a plurality of web pages to client systems that request the webpages, thereby facilitating browsing on the Internet.

The processor system 260 may include any one of, some of, any combination of, or all of multiple parallel processors, a single processor, a system of processors having one or more central processors and/or one or more specialized processors dedicated to specific tasks. The processor system 260 may implement the machine instructions stored in the memory system 250.

In an alternative embodiment, the communication interface 270 allows the server system 104 to interface with the network 112. In this embodiment, the output system 230 sends communications to the communication interface 270. The communications system 275 communicatively buttons the output system 230, the input system 240, the memory system 250, the processor system 260 and/or the input/output system 280 to each other. The communications system 275 may include any one of, some of, any combination of, or all of one or more electrical cables, fiber optic cables, and/or sending signals through air or water (i.e., wireless communications), or the like. Some examples of sending signals through air and/or water include systems for transmitting electromagnetic waves such as infrared and/or radio waves and/or systems for sending sound waves.

The input/output system 280 may include devices that have the dual function as the input and output devices. For example, the input/output system 280 may include one or more touch sensitive screens, which display an image and therefore are an output device and accept input when the screens are pressed by a finger or a stylus, for example. The touch sensitive screens may be sensitive to heat and/or pressure. One or more of the input/output devices may be sensitive to a voltage or a current produced by a stylus, for example. The input/output system 280 is optional and may be used in addition to or in place of the output system 230 and/or the input device 240.

FIG. 3 shows a perspective view of a plurality of payment components 300, according to the present invention.

The payment components 300 may include a payment system 310 and a cash register system 320. The payment system 310 and a cash register system 320 may be a computational device configured to execute the non-transitory storage for translating spoken language (FIG. 2B, 255) of the system for translating spoken language 100.

The payment system 310 may include a pay keypad 312 with a first visual interface 314 that may be utilized by a first individual to select a first language in which the first individual may speak and/or read. The first language may be displayed on the first visual interface 314 and is selected from the group consisting of English, Espanol (Spanish), Francois (French), Italiano (Italian), Deutsche (German), Turkce (Turkey), Portugues (Portugese), Pyccknn (Russian), or the like. The first visual interface 314 may be a touch activated interface 315 or the like or be activated by a stylus 316 or the like. The first visual interface 314 may be supported by a stand 318 to hold the touch activated interface 315 in an upright position.

The cash register system 320 may include a base keyboard 322, a second visual interface 324, and a scanner 326. The base keyboard 322 may be utilized to input and output product information into the cash register system 320. The second visual interface 324 may be in electrical communication with the base keyboard 322 and may also be a touch activated interface 315 or the like or be activated by a stylus 316 or the like. The second visual interface 324 utilized by a second individual to select a second language in which the second individual may speak and/or read. In this manner, each of the first individual and the second individual is able to utilize a preferred language. The second language may be displayed on the second visual interface 324 and is selected from the group consisting of English, Espanol (Spanish), Francois (French), Italiano (Italian), Deutsche (German), Turkce (Turkey), Portugues (Portugese), Pyccknn (Russian), or the like. The scanner 326 may also include a stand 327 to support and hold the scanner 326 in an upright position.

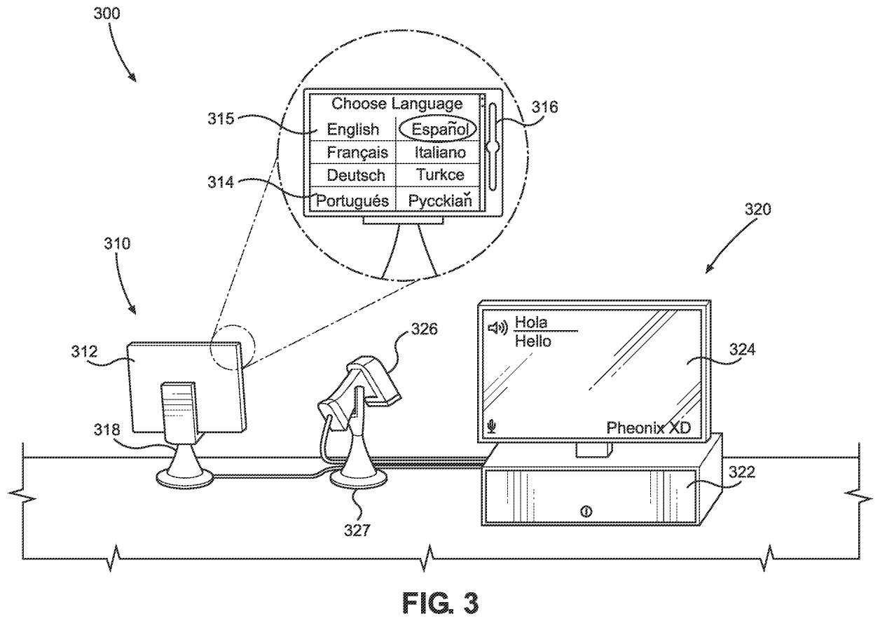

FIG. 4 shows a perspective view of a first visual interface 314 and a second visual interface 324 of a system for translating spoken language 100, during use to select a preferred language.

The system for translating spoken language 100 further comprises a first microphone 315 disposed on an upper corner 317 of the first visual interface 314 configured to accept auditory input from the first individual, and a second microphone 325 disposed on an upper corner 327 of the first visual interface 324 configured to accept auditory input from the second individual that is disposed on the second visual interface 324.

In various embodiments, the microphones 315, 317 are embedded within the respective visual interfaces 314, 324 of the payment components 300, and may be activated once a particular function of the non-transitory storage for translating spoken language (FIG. 2B, 255) is activated, such as clicking or selecting an indicia 329 disposed on one or more of the first visual interface 314 and the second visual interfaces 324.

In various embodiments, the system for translating spoken language 100 is configured to recognize speech, convert it to text, and translate the text to a desired output language, such that the first visual interface 314 and the second visual interface 324 are configured to display the outputted information in the language selected by the customer. In this manner, during use, a speaker may speak in his or her preferred language, and a listener may read what is spoken by the speaker in his or her preferred language.

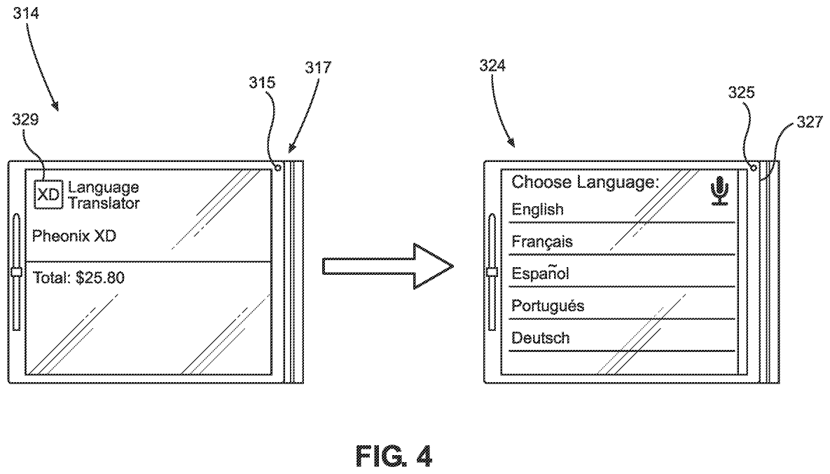

FIG. 5 shows a perspective view of a mobile app 400 of the system for translating spoken languages.

The system for translating spoken language 100 may include a mobile app 400 that includes an interface 410 displayed on a hand-held device (FIG. 1, 122).

The interface 410 may have the same features that the first visual interface (FIG. 4, 314) and a second visual interface (FIG. 4, 324) have or the like.

In various embodiments, during use, the first individual and the second individual each select a preferred language for use of the system for translating spoken languages 100. As each individual speaks, the spoken language is converted to text for viewing by the other individual in his or her preferred language by a non-transitory storage for translating spoken language (FIG. 2B, 255). The text generated by the system for translating spoken languages 100 is displayed on the first visual interface 314 and the second visual interface 324. In this manner, two individuals who speak and/or read different languages may be able to effectively communicate with one another using the system of the present invention.

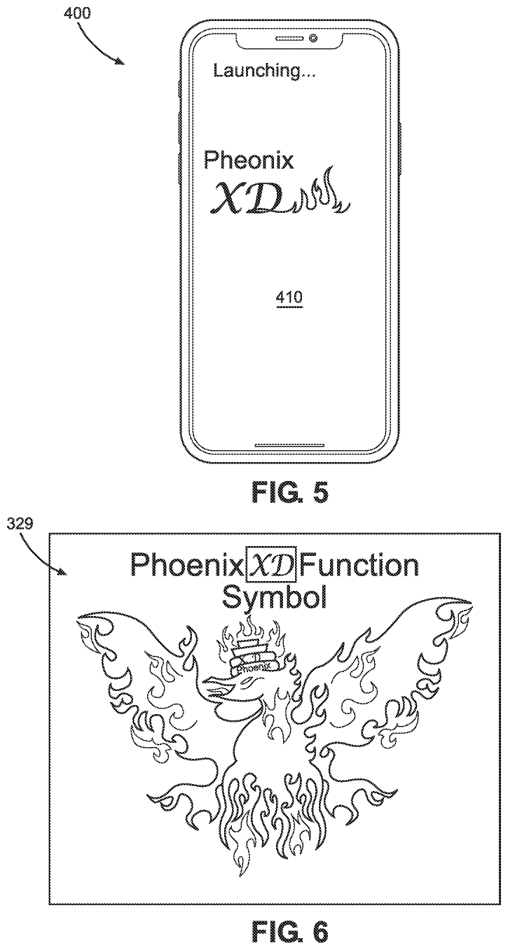

FIG. 6 shows an indicia 329 disposed on one or more of the first visual interface 314 and the second visual interfaces 324.

The indicia 329 may be clicked on or depressed to activate the first microphone 315 disposed on an upper corner 317 of the first visual interface 314 and the second microphone 327 disposed on an upper corner 327 of the second visual interface 324.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system for translating spoken language, comprising:
a server system with a processor system, a communications interface, a communications system, an input system and an output system, the server system having access to a communications network;
a memory system with an operating system, a communications module, a web browser module, a web server application, and a non-transitory storage media for translating spoken language, the memory system is in communication with the server system through the communications network; and
a plurality of payment components;
wherein the payment components execute the non-transitory storage media for translating spoken language of the system for translating spoken language that resides on the memory system.

2. The system according to claim 1, further comprising a client system that accesses the server system via the communications network.

3. The system according to claim 2, wherein the client system is selected from the group consisting of a smart phone, a tablet computer, a laptop computer, or a personal computer.

4. The system according to claim 1, wherein the payment components include a payment system and a cash register system.

5. The system according to claim 4, wherein the payment system includes a pay keypad with a first visual interface that is utilized by a first individual to select a first language in which the first individual speaks and/or reads.

6. The system according to claim 5, wherein the first visual interface is a touch activated interface.

7. The system according to claim 5, wherein the first visual interface is supported by a stand to hold the first visual interface in an upright position.

8. The system according to claim 5, wherein the first language displayed on the first visual interface is selected from the group consisting of English, Espanol (Spanish), Francois (French), Italiano (Italian), Deutsche (German), Turkce (Turkey), Portugues (Portugese), and Pyccknn (Russian).

9. The system according to claim 4, wherein the cash register system includes a base keyboard, a second visual interface, and a scanner.

10. The system according to claim 9, wherein the base keyboard is utilized to input and output product information into the cash register system.

11. The system according to claim 9, wherein the second visual interface is in electrical communication with the base keyboard and is a touch activated interface.

12. The system according to claim 9, wherein the second visual interface is utilized by a second individual to select a second language in which the second individual speaks and/or reads.

13. The system according to claim 12, wherein the second language displayed on the second visual interface is selected from the group consisting of English, Espanol (Spanish), Francois (French), Italiano (Italian), Deutsche (German), Turkce (Turkey), Portugues (Portugese), and Pyccknn (Russian).

14. The system according to claim 9, wherein the scanner includes a stand to support and hold the scanner in an upright position.

15. The system according to claim 9, further comprising a second microphone disposed on an upper corner of the second visual interface configured to accept auditory input from the second individual.

16. The system according to claim 15, wherein the second microphone is embedded into the upper corner of the second visual interface.

17. The system according to claim 5, further comprising a first microphone disposed on an upper corner of the first visual interface configured to accept auditory input from the first individual.

18. The system according to claim 17, wherein the first microphone is embedded into the upper corner of the first visual interface.

19. The system according to claim 18, further comprising an indicia disposed on the first visual interface and the second visual interfaces.

20. The system according to claim 19, wherein the indicia is clicked on or depressed to activate the first microphone and the second microphone.
